(19) United States
(12) Patent Application Publication
(10) Pub. No.: US 2012/0330901 A1
(43) Pub. Date: Dec. 27, 2012

(54) VALIDATION OF INGESTED DATA

(75) Inventors: Varun Bhagwan, San Jose, CA (US); Tyrone W. A. Grandison, San Jose, CA (US); Daniel F. Gruhl, San Jose, CA (US); Kilian M. Pohl, Santa Cruz, CA (US)

(73) Assignee: INTERNATIONAL BUSINESS MACHINES CORPORATION, Armonk, NY (US)

(21) Appl. No.: 13/604,157

(22) Filed: Sep. 5, 2012

Related U.S. Application Data
(63) Continuation of application No. 13/016,407, filed on Jan. 28, 2011.

(51) Int. Cl. G06F 17/30

(52) U.S. Cl. 707/690; 707/E17.005

(57) ABSTRACT

Methods and systems for validating ingested data are disclosed. In accordance with the methods and systems, data elements can be received for storage in slots of an individual descriptor in a storage medium. In addition, at least one validation test can be selected based on a weighting of the data elements that indicates a respective degree of importance of the data elements. The selected validation test or tests can be applied to the data elements stored in the slots to generate respective validation results. Further, a validation score indicating a sufficiency of the stored data elements can be generated based on the validation results.

### RELATED APPLICATION INFORMATION

This application is a Continuation application of co-pending U.S. patent application Ser. No. 13/016,407 filed on Jan. 28, 2011, incorporated herein by reference in its entirety.

This application is related to commonly assigned application Ser. No. 13/015,971, filed on Jan. 28, 2011 and incorporated herein by reference.

### BACKGROUND

1. Technical Field

The present invention relates to data ingest and, more particularly, to validating ingested data.

2. Description of the Related Art

Analytics has increasingly become an important tool in developing evidence-based decision making in a large variety of businesses. In particular, the development has been fueled by a growing desire to base business decisions on non-traditional sources of information. One challenge that arises from using non-traditional information sources is that the sources are often not configured to provide the availability and accuracy of data feeds to which users are accustomed. As such, the issue creates a mismatch between the expectations of a user and the capabilities and the characteristics of data sources. Analytics techniques can provide a means for addressing this challenge.

### SUMMARY

One exemplary embodiment is directed to a method for validating ingested data. In accordance with the method, data elements are received for storage in slots of an individual descriptor in a storage medium. In addition, at least one validation test is selected based on a weighting of the data elements that indicates a respective degree of importance of the data elements. The selected validation test(s) are applied to the data elements stored in the slots to generate respective validation results. Further, a validation score indicating a sufficiency of the stored data elements is generated based on the validation results.

Another embodiment is directed to a computer readable storage medium comprising a computer readable program code. The computer readable program code when executed on a computer causes the computer to receive data elements for storage in slots of an individual descriptor. The computer readable program code when executed on a computer also causes the computer to select at least one validation test based on a weighting of the data elements that indicates a respective degree of importance of the data elements. The computer readable program code when executed on a computer further causes the computer to apply the selected validation test(s) to the data elements stored in the slots to generate respective validation results. In addition, the computer readable program code when executed on a computer causes the computer to generate a validation score indicating a sufficiency of the stored data elements based on the validation results.

An alternative embodiment is also directed to a method for validating ingested data. In accordance with the method, data elements are received for storage in slots of an individual descriptor in a storage medium. Further, at least one validation test is applied to the data elements stored in the slots to generate respective validation results. Additionally, a validation function is selected based on a weighting of the data elements that indicates a respective degree of importance of the data elements. Moreover, a validation score indicating a sufficiency of the stored data elements is generated by applying the validation function to the validation results.

A different embodiment is directed to a system for validating ingested data. The system includes a weighting module that is configured to assign weights to data elements to which storage slots of an individual descriptor are dedicated, wherein the weights indicate respective degrees of importance of the data elements. Further, the system includes a validation unit that is configured to apply at least one validation test to the data elements stored in the slots to generate respective validation results. The system also includes a controller that is configured to receive the data elements, to store the data elements in storage slots of the individual descriptor in a storage medium and to generate a validation score indicating a sufficiency of the stored data elements based on the weights and on the validation results.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an embodiment of a system for validating ingested data.

FIG. 2 is a block/flow diagram of an embodiment of a method for validating ingested data.

### DETAILED DESCRIPTION OF PREFERRED EMBODIMENTS

Exemplary embodiments described herein below enable a small number of operators to monitor a large number of disparate sources of information by monitoring content flows and validating the sufficiency of information obtained. In particular, embodiments can permit different users to utilize the same set of data and apply customized validation techniques that are tailored to particular analyses the users wish to conduct. For example, as described in more detail herein below, in one exemplary application, the set of data can represent a patient record. Here, various physicians or specialists, such as cardiologists, neurologists, etc., can customize the validation of the patient record in accordance with the specific analysis the physician or specialist seeks to perform. For example, different validation methods employed can indicate whether the patient record is sufficient to permit the physician or specialist to provide an opinion as to whether the patient suffers from coronary heart disease, a neurological disorder, etc. Thus, the validation methods applied are based on the particular analysis conducted by a user. These features can improve efficiency, as they enable a user to conduct one type of analysis of a set of data even though the record may be insufficient to conduct other types of analyses. As such, in situations in which a patient's record is incomplete, users need not delay in providing an opinion until they receive a complete record, as the customized data validation methods can inform users of the sufficiency of the data for their particular purposes, thereby permitting users to utilize incomplete records to make informed decisions regarding a subject.

Furthermore, embodiments can be configured to examine very high level features of information streams and employ models of expected behavior to provide monitors that do not need intimate knowledge of the data they are monitoring. Thus, embodiments can be quickly and inexpensively deployed during system development and can provide a high level monitoring for agile data-driven development. In accordance with one embodiment, a monitoring system can be added to software packages that are targeted towards Smarter Analytics Applications. The system can be configured to check the consistency and correctness of data processed by these software packages at different stages of the data ingest and for different analytic purposes. Adding monitoring to existing software packages will lead to increased robustness and efficiency of those systems for several reasons. For example, incoming data violating software requirements can be flagged and excluded from further processing. Errors can be caught at early stages of the ingest to minimize downtime of the system further downstream. In addition, users can be warned about inconsistent and erroneous data.

A number of specific techniques for monitoring data flows and identifying some of the various ways in which they may fail are described herein below. In a preferred embodiment, aspects of the present principles are described for expository purposes with respect to a healthcare field application, particularly for patient record. However, the present principles can be applied in other fields and other complex entities in those fields, where those entities are composites of different types of information. For example, the present principles can be applied in the fields of finance, trading, the military and health care, and many other fields in which decisions are made based on different types of data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

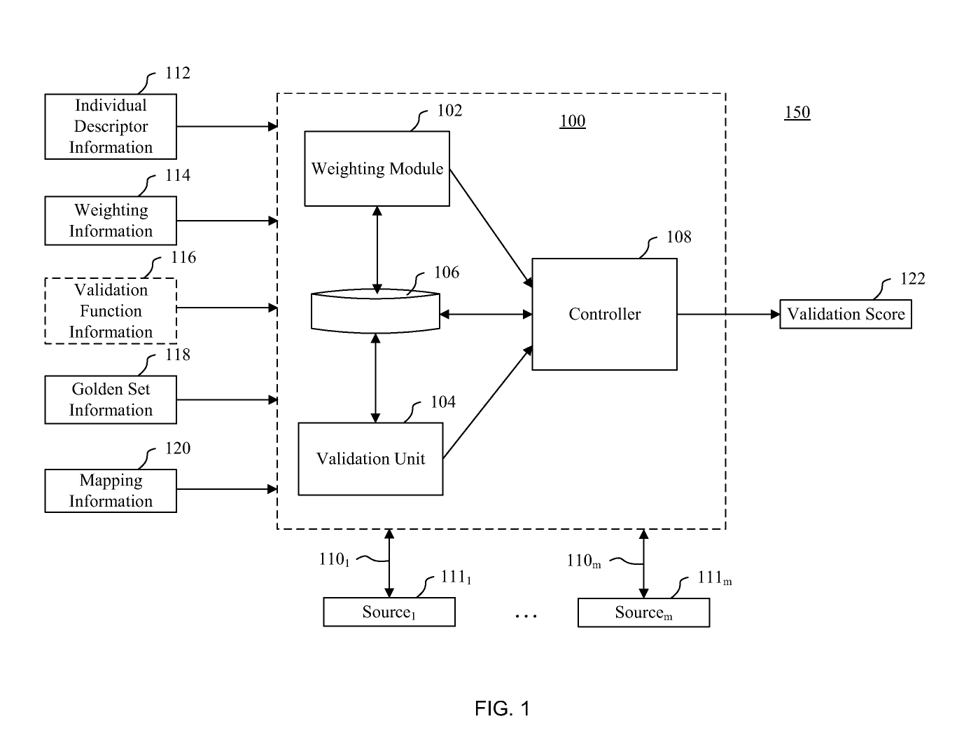

Referring now to the drawings in which like numerals represent the same or similar elements and initially to FIG. 1, a system 100 for validating ingested data in accordance with one exemplary embodiment is illustrated. The system 100 can include a weighting module 102, a validation unit 104, a storage medium 106 and a controller 108. The system 100 can be implemented in a system 150 including sources 111₁-111ₘ from which data can be retrieved through corresponding links 110₁-110ₘ. The data sources 111₁-111ₘ can be remote or local and can be distributed through a private network, such as a corporate network, a public network, such as the internet, and/or a combination of public and private networks. Furthermore, the links 110₁-110ₘ to sources 111₁-111ₘ can be part of such networks and can be wired or wireless. In one exemplary implementation, the sources 111₁-111ₘ can include various nodes on a local network in a hospital and can also include nodes in a plurality of different hospitals and/or in a payer network, such as a medical insurance network. Various elements can be input in the system 200 to enable the system to determine and output a validation score 122, which can indicate whether a sufficient amount of valid data has been retrieved from the sources for one of a variety of different purposes. For example, one or more individual descriptors 112 describing a record of interest can be input to the system 100. The data elements can provide material for analysis of a subject. In a health care application, an individual descriptor can represent patient data as a plurality of n slots: {p₁, . . . , . . . , . . . , . . . , . . . , . . . , . . . , . . . , pₙ}, where each slot can include one or more portions of different patient data, such as laboratory test results, x-ray images, magnetic resonance imaging (MRI) images, medical reports, etc., that provide material for different types of analyses of a patient's health. For example, as described in more detail below, the descriptor can enable a cardiologist to determine whether a patient suffers from heart disease, can enable a neurologist to determine whether a patient suffers from a neurological disease, etc. The data for a slot can be retrieved or received from one or more sources 111₁-111ₘ, including a combination thereof, as well as from one or more other slots. In one exemplary embodiment, an individual descriptor can be a set of slots that form a complete patient record. The controller 108 can store the descriptors 112 in the storage medium 106.

For each individual descriptor, a set of weights {w₁, . . . , . . . , . . . , . . . , . . . , . . . , . . . , . . . , wₙ} can be applied to the slots of the individual descriptor. For example, the weighting module 102 can assign each weight wᵢ to a corresponding slot pᵢ in accordance with value or weighting information 114 input by a user. The assignment of the weight wᵢ to a corresponding slot pᵢ effectively acts as an assignment of the weight to the data element(s) intended for the slot pᵢ. The weighting information can be input by a subject matter expert to prioritize the data slots, or data intended for the slots, and thereby indicate a degree of importance of data in a slot in an analysis of a subject. The information 114 can detail a collection of slots in which data elements that are relevant to the analysis of the subject can be stored. For example, for purposes of conducting an analysis to determine whether a patient suffers from heart disease, a cardiologist may prioritizes data slots by assigning a higher weight to slots dedicated to an electrocardiography (EKG) report/echocardiogram (Echo)/angiogram than slots dedicated to X-Ray/Neurology data. In another example, for purposes of conducting an analysis to determine whether a patient suffers from tuberculosis, a physician can assign a higher weight to a chest X-ray slot, slots for laboratory tests of sputum, etc., over other data slots.

Mapping information 120 can also be input to the system 100. For example, a user or other system element can input information describing check type mappings {c₁, . . . , . . . , . . . , . . . , . . . , . . . , . . . , . . . , cₙ} and slot type mappings to indicate which data validation checks should be performed for corresponding data slots. For example, any check cᵢ can be applied to a corresponding data slot pᵢ to ascertain the validity of the data in the respective slot. For any slot, there can be one or more validation checks. Additionally, one or more validation checks can analyze the data in two or more slots. Finally, one or more validation checks can be overall validation checks that encompass two or more individual descriptors. For example, a validation check can encompass a large corpus of patients. Thus, each slot pᵢ can be associated with a customized set of one or more validation checks through the check type mappings. Examples of specific validation checks are described in more detail herein below. Based on the mapping information 120, the controller 108 can generate slot type mappings and check type mappings. A slot type mapping is a table that lists slots {p₁, . . . , . . . , . . . , . . . , . . . , . . . , . . . , . . . , pₙ} and associates each slot with its corresponding validation check(s). In turn, a check type mapping is a table that lists validation checks {c₁, . . . , . . . , . . . , . . . , . . . , . . . , . . . , . . . , cₙ} and associates each validation check with its corresponding slot(s). The slot type and check type mappings can be predetermined and pre-stored in the storage medium 106 for access by the validation unit 104 to enable the validation unit 104 to determine appropriate validation tests to apply to any descriptor. It should be noted that “validation check(s)” are used interchangeably with “validation test(s)” herein, as the terms have the same meaning.

It should be further noted that one or more validation checks can employ a golden data set, which can be input by a user or another system element to the system 100. The golden data set can be a model descriptor set. For example, the golden data set can represent the set of slots that any individual descriptor should include. For example, the controller 108 can use the golden data set to define a (global) list of files and directories that exist for all individual descriptors. Thus, for each new individual descriptor or data set, the system 100 can check if all files and directories exist and are consistent. Other uses of the golden data set for validation purposes are described in more detail herein below.

Optionally, a user or other system element can input validation function information 116 to the system 100 that describes a validation function or describes a selection of a validation function. Alternatively, the validation function can be selected by the controller 108. The validation function (V) can be applied to validation checks conducted on an individual descriptor to enable the system 100 or a user to determine whether data stored in the individual descriptor is sufficient for conducing an analysis of the subject of the descriptor. For example, in one embodiment, the validation unit 104 can be configured to perform validation checks, described in more detail below, only for slots that are weighted above a threshold weight. As noted above, the validation check(s) conducted for any slot can be pre-determined in accordance with the mapping information described above. The validation function, when applied to the conducted validation check(s), can provide a validation score V(P) 122 for a given individual descriptor P. Here, the validation score 122 can represent the composite result of the checks done on the various slots for an individual descriptor. The validation score and the validation function can be based on the goal of the weighting applied to analyze the data in the individual descriptor. For example, in the cardiologist example provided above, the controller 108 can apply the function V to the checks conducted to determine the percentage of valid Echo videos that are present in the descriptor. For example, the function can be configured to output a passing score only if over 80% of Echo videos are present in the descriptor. In addition, the expert can configure or select a validation function that would yield a validation score indicating that the descriptor includes valid data that is sufficient for the cardiologist to conduct his analysis of whether a patient suffers from heart disease. For example, the validation function can be configured to apply a passing score only if a selected subset of Echo videos are valid and present and 60% of other videos are valid and present. Thus, the validation score can indicate a sufficiency of the data stored in an individual descriptor with respect to conducting an analysis of a subject.

In accordance with another example, the validation function can output a passing score only if a maximal percentage of valid data is stored in the slots of the individual descriptor. Similarly, the validation function can be based on whether the most recently generated data is included in the slots and/or whether specific-data slots are filled with valid data. When set to output a passing score on maximal data coverage, the validation function determines whether the number of slots including valid data is equal to the maximum number of slots and, if so, provides a passing score. When set to output a passing score on most recent data coverage, the validation function determines if the valid data in the slots have timestamps that are in a recent range of the current time, where the recent range is user-specified, e.g. the last 10 seconds, the last 10 minutes, etc. If the time stamps are within the recent range, then the validation function outputs a passing score. When set to output a passing score on specific data coverage, the validation function checks that pre-specified slots have valid data in them and, if so, outputs a passing score.

It should be noted that default validation functions can be stored in the storage medium such that the validation unit 104 can trigger a default validation function based on the weighting applied to the descriptor analyzed. For example, the validation unit 104 can be configured to trigger and apply a given validation function to analyze the validation checks conducted on slots A, B and C if slots A, B and C have respective weights X, Y, Z or above. Alternatively or additionally, the controller 108 can permit a user to define a validation function by providing the user with various options and receiving a user-selection of the options as the validation function information 116. Alternatively or additionally the user may simply input the validation function to the system 100 as the validation function information 116. It should be further noted that the composite validation score V(P) is not a requirement for the system to function—in other words, specific pieces of data for one or more individual descriptors can be validated without necessarily generating a validation score.

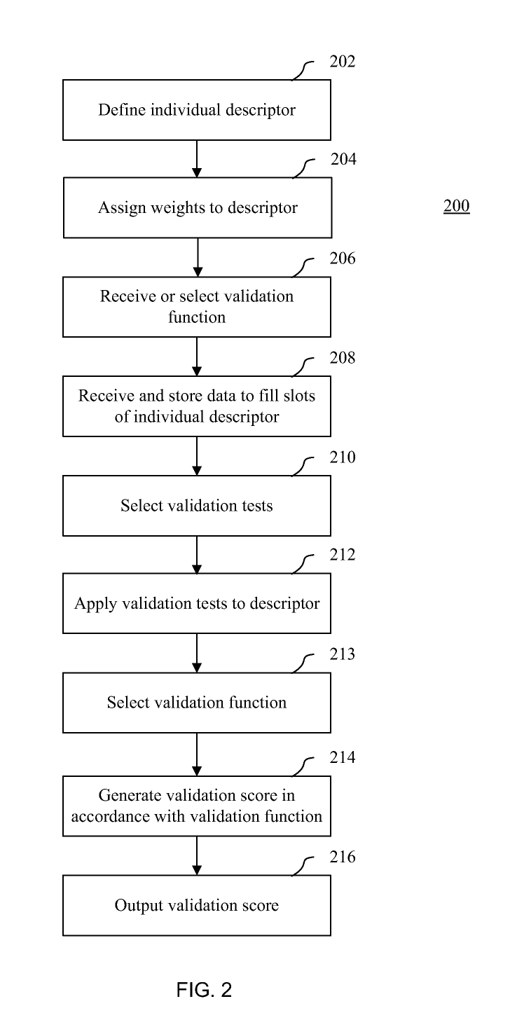

With reference now to FIG. 2, with continuing reference to FIG. 1, a method 200 for validating ingested data in accordance with one exemplary embodiment is illustrated. It should be noted that the method 200 can be implemented in a program that can be stored on the storage medium 106 and performed by various elements of the system 100, as described in more detail herein below.

The method 200 can begin at step 202, in which the controller 108 can define an individual descriptor. For example, as noted above, a user, such as a physician or specialist in a health care application of the method, can input individual descriptor information 112 to permit the controller 108 to generate the individual descriptor. The controller 108 can generate a generic individual descriptor and can fill corresponding slots with any other data provided by the user. The individual descriptor can be defined once when a patient is first entered into the system 100.

At step 204, the weighting module 102 can assign and apply weights to the descriptor based upon input by a subject matter expert. For example, as noted above, a user can assign weights wᵢ to any one or more slots in accordance with weighting information 114 input by a user. As stated above, the weights can indicate a degree of importance of data in a slot in an analysis of a subject, such as an analysis of whether or not a patient suffers from heart disease. The weighting module 102 can automatically assign a weight of zero to any unselected slots. It should be noted that the weights assigned by any particular user can be stored as an individual entity that can be retrieved for subsequent use. For example, the user can apply the weights to a generic descriptor and can store and name the weights as appropriate in the storage medium 106. Thereafter, the controller 108 can provide the user with a listing of sets of weights and corresponding names to enable the user to select a set of weights by name and have the weighting module 102 apply the selected weights to any one or more descriptors.

At step 206, the validation unit 104 can select or receive one or more validation functions to apply to the individual descriptor. As described above, the validation unit 104 can select the validation function based on the weights applied to the descriptor. Alternatively or additionally, the validation unit 104 can select or generate the validation function based on information 116 input by a user or the validation unit 104 can receive the validation function itself from the user.

At step 208, the controller 108 can direct the system 100 to retrieve or receive data from any one or more sources 111₁-111ₘ to fill one or more slots of the individual descriptor. For example, the controller 108 can initiate the retrieval or receipt of information in response to a user request to display, retrieve or update the information in a descriptor. Alternatively or additionally, step 208 can be implemented automatically in response to the performance of step 202. Moreover, the controller 108 can store the retrieved data elements in corresponding slots in the storage medium 206.

It should be noted that steps 204 and 206 can be implemented at any time after the individual descriptor is defined and stored at step 202. In addition, steps 204 and 206 can be implemented at any stage of ingest of the data. For example, the steps 204 and 206 can be performed when the descriptor is completely empty, partially full or completely full. Furthermore, a set of one or more weights and a set of one or more corresponding validation functions can be recorded and used as separate entities. For example, in the health care application, several different physicians and specialists can have their own specific set of weights and validation functions applied to the same individual descriptor. The different entities can be stored in the storage medium and can be accessed and selected by a physician at any time the physician wishes to conduct a validation test or obtain a validation score. For example, when a physician wishes to conduct an analysis of the patient's health, the physician can select a desired set of weights and validation functions and can prompt the system to apply the validation tests to determine the current state of the individual descriptor at any time after the descriptor is defined and stored. Further, in response to receiving a failing validation score at step 216 (described in more detail below), the user can prompt the controller 108 to update the individual descriptor of a patient by repeating the retrieval step 208.

At step 210, the validation unit 104 can select validation tests to apply on an individual descriptor. For example, the validation unit 104 can select on which slots to apply corresponding validation tests based upon the weighting of the slots, as described above. Furthermore, the validation unit 104 can determine which validation tests to conduct on any given slot based on the mappings described above with respect to mapping information 120. Thus, using the mappings, the validation unit 104 can select one or more validation tests, from a plurality of validation tests, that correspond to slots selected based on the weightings.

At step 212, the validation unit 104 can apply the selected validation tests to slots of the individual descriptor to generate validation results. Examples of validation tests are described in more detail below.

At step 213, the controller 108 can select a validation function to apply to the results of the validation tests. For example, as noted above, the controller 108 can select the validation function from a plurality of validation functions based on the weights applied by the weighting module 102 at step 204. Alternatively, a user can specify the validation function. For example, as noted above, the user may input validation function information 116 with the weighting information 114. The validation function information 116 can itself define a validation function to be applied to the individual descriptor or the validation function information 116 can indicate a user-selection of a validation function from a plurality of validation functions displayed to the user by the controller 108. As such, the controller 108 can generate a validation function in accordance with a user-specification of the validation function. Moreover, as described above, the validation function can be configured to return validation scores that indicate whether a percentage of valid data of a certain type of data is present in the slots of the descriptor, whether a maximal percentage of valid data is present in the slots of the descriptor, whether most recently generated data is included in the slots and whether specific-data slots are filled with valid data, in addition to other examples. Furthermore, it should be noted that the controller 108 can select and apply a plurality of validation functions to an individual descriptor if the user specifies their application and/or if a plurality of different functions meet weighting criteria with respect to data stored in an individual descriptor.

At step 214, the controller 108 can generate a validation score in accordance with the validation function. For example, the controller 108 can apply the validation function to the results of the validation tests to generate the validation score. As described above, the controller 108 can generate the validation score based on the weights of assigned or applied to the data elements of an individual descriptor. For example, as described above, based on the weighting, the validation unit 104 can select validation tests that it applies to obtain validation results from which the controller 108 computes the validation score. In addition, the controller 108 can select the validation function it applies based on the weighting to compute the validation score, as described above.

Furthermore, the validation score can indicate a sufficiency of the data elements stored in the slots of the descriptor. For example, the validation score can indicate a sufficiency of the stored data elements with respect to conducting an analysis of the subject upon which the descriptor is based. For example, in the cardiologist example provided above, the cardiologist would be interested in conducting an analysis of the Echocardiogram (Echo) test results for his patients. Accordingly, the relevant descriptors for his patients will be the Echo slots, which can be weighted as described above with respect to step 204. Thus, upon data ingest at step 208, the validation unit 104 can automatically select appropriate validation tests that examine Echo data. In this example, upon completion of the retrieval or receipt of data at step 208, the validation unit 104 can execute the validation tests on the Echo slots and, based on the results of the validation tests, the controller 108 can produce a validation score that will reflect whether sufficient data was successfully fetched or not. For example, as noted above, the controller 108 can select the appropriate validation function and can apply the validation function to the results of the validation tests to generate the validation score. Here, the validation function can be configured to generate a validation score indicating whether the most recent Echo data has been stored in the slots of an individual descriptor and/or whether all relevant Echo data is valid and present in the individual descriptor. As stated above, the validation function can be configured to generate a validation score indicating whether the data stored in the slots of the descriptor is sufficient to enable a physician or specialist to determine whether a patient suffers from heart disease.

At step 216, the controller 108 can output the validation score to a user with the individual descriptor. For example, the controller 108 can direct the system 100 to display the validation score to the user when the data stored in the individual descriptor is output or displayed to the user.

It should be understood that the present principles can utilize many different types of validation tests to generate a validation score. Examples of the validation tests that can be employed in a health care application are described herein below. However, it should be noted that validation tests specific to other fields and other types of data can be utilized in the method 200.

The validation tests can differ in the degree of expert knowledge about the data and the system. Validation tests that are dependent on a minimal knowledge of the data and the system are described initially, followed by a description of examples that are dependent on an advanced knowledge of the data and the system.

In accordance with one example, a validation test can be directed to determining whether and which data slots are empty. For example, in the cardiologist example provided above, the cardiologist would be interested to know if and or when the laboratory technician's notes associated to an EKG of interest is absent. This could be an indication of complexity in the case and a need to launch a further investigation. Another exemplary validation test can be configured to determine and flag files stored or referenced in one or more slots that have zero length. For example, the validation unit 104 can perform the following check on any given slot of an individual descriptor to determine whether files of zero length are stored or referenced: [“test-s blub.txt”] echo “Not Empty”∥echo “Empty”. Another validation test that the validation unit 104 can conduct can include an empty directory test. Here, the validation unit 104 can determine and report empty directories referenced in one or more slots of an individual descriptor by executing the following: [“$(Is-A/path/to/directory)”] && echo “Not Empty”∥echo “Empty”.

The validation unit 104 may also conduct one or more simple inconsistent data tests. For example, the validation unit 104 can flag inconsistent data based on the name and size of a file stored in a slot of the individual descriptor. One example of a simple inconsistent data test is a file extension test. For example, the validation unit 104 can determine whether the file extension of a file stored in a slot matches the file type of the file. For example, with respect to Portable Network Graphics (PNG) images, the validation unit 104 can implement a file extension test as follows: “‘file $FILE|cut-d’:‘-f2|cut-d’,‘-f1’”=“PNG image data” && echo “not correct”∥echo “correct”. Another example of a simple inconsistent data test is a file name test. For example, the validation unit 104 can compare the naming convention of a file stored in a storage slot of an individual descriptor to the golden data set to determine whether the naming convention matches a naming convention of at least one file in a golden data set, which is a model set of slots specifying the slots that any individual descriptor should include, as described above.

Another example of a validation test is an entropy file test. Here, the validation unit 104 can determine whether the entropy of a specific file in a slot of the individual descriptor is within a bound of entropies of files of the golden data set that match the specific file's naming convention. The entropy file test can detect the presence of black or blank images.

A simple data and output file test provides another example of a validation test. To implement the test, the controller 108, as indicated above, can define a (global) list of files and directories that exist for all individual descriptors. For each individual descriptor, the validation unit 104 can compare the individual descriptor to the golden data set to determine whether all files and directories exist and are consistent with the golden data set. Furthermore, the controller 108 can be configured to record all naming conventions across all of the data provided in the golden data set. For each naming convention, the controller 108 can record the other files present in one or more or all individual descriptors that have at least one file with that naming convention. The validation unit 104 can test each new individual descriptor for which data retrieval is completed to determine whether the descriptor has all the files of the global list and also whether each file complies with a naming convention specific to the type of the file. The same process can be repeated for the output of each stage of the individual descriptor.

A different example of a validation test is a simple output information test. The test can be configured to determine whether the information of the ingest is reasonable. Examples are disease distributions based on the golden data set. Another illustrative example is an embodiment with a golden data set with 10 disease documents per a single clinical note and where the ingested data set includes 3 disease documents per single clinical note. In this case, there is an expectation that the ingested data ratio of disease documents to clinical notes should correlate to that of the golden set. In the example, a large deviation of the disease distribution in the ingested data from the disease distribution of the golden data set is a possible indication of missing or dropped data.

A simple corrupted data test provides another example of a validation test. In accordance with the simple corrupted data test, the validation unit 104 can determine whether the data stored in the slots of an individual descriptor or the output of the ingested data is corrupted. For example, for each new individual descriptor, the validation unit 104 can implement the corrupted data test by performing the Empty Data Test, Empty Directory Test, and the simple Inconsistent Data Test described above at data ingest and/or at the output of the ingested data. The ingested data is the data received and stored in respective slots of an individual descriptor.

The validation unit 104 can also be configured to perform a simple mid-run crash test, which is another example of a validation test. For example, the controller 108 can generate and reference records of the maximum processing time for each stage of ingest of data to fill the slots of the golden data set. The controller 108 can determine the records of the maximum processing times based on a statistical analysis of the data ingest conducted for a set of exemplary individual descriptors. To implement the mid-run crash test, the validation unit 104 can record the maximum processing time for each stage of the ingest of data for a given individual descriptor. The validation unit 104 can automatically detect a crash of the ingest at any stage if the processing time recorded for the given descriptor violates any of the time constraints determined for the golden data set. The following is a batch script that the validation unit 104 can utilize to implement the mid-run crash test: sleep Xs; [execute Empty Directory Test, Empty Data Test, Simple Inconsistent Data Test].

Turning now to validation tests that employ advanced data and/or system knowledge, the rules for an advanced inconsistency test, an advanced corrupt data test, and an advanced mid-run crash test are similar to the simple counterparts described above. However, these advanced tests are now explicitly defined by the expert customizing the system 100. The customization feature provides the system 100 with the flexibility to address issues that might not be well captured or difficult to extract from the golden data set. Examples of aspects that can be implemented in these advanced tests are as follows. One such aspect can test whether general information, such as patient demographic information in the health care example, is included in any individual descriptor. Another exemplary aspect is the institution of one or more of a variety of correspondence checks. For example, the advanced validation tests can determine whether the number of videos stored in the slots of a given descriptor match a respective number of medical reports providing interpretations of the videos. The validation tests can be configured to determine whether image data or other data is within a reasonable range. For example, the validation unit 104 can conduct a validation test to determine and flag data that depicts flat ventricular tachycardia (VT) lines for a live patient. Other validation tests can be configured to determine whether disease codes in a catalog are correct.

It should be noted that the selection of validation tests at step 210 can be dependent on the type of data stored in the slots of the descriptor. For example, certain validation tests are applicable to only specific types of data, while others are applicable to any type of data. For example, the entropy file test is applicable to images while the empty data slot test is applicable to all types of data. Thus, the validation unit 104 can be configured to examine the type of data included in each slot and select any corresponding validation tests that match the type.

It should be noted further noted that the validation unit 104 can be configured to conduct other types of tests. For example, the validation unit 104 can be configured to determine whether disease distributions are abnormal, based on external resources, such as domain specific publications related to the space. For example, the identification of fifty cases of Tachycardia in the last week in a rural population, which traditionally had a low incident rate over the last 50 years (as, e.g., established by a paper in the Journal of the American College of Cardiology), would be a signal of an abnormality or an epidemic. In this specific example, where the test can signal the development of an epidemic, the validation unit 104 and/or the controller 108 can generate and display a message indicating the abnormality of the ingested data.

As indicated above, the present principles can be applied in a variety of different fields. For example, in the field of trading stocks and securities, the slots of the individual descriptor can be allocated to data elements that can provide material enabling the analysis and estimation of the future value of a stock. For example, the data elements can provide information on the current and historical prices of a stock, the current assets of a company that issued the stock, the prices and assets of stocks in similar businesses, etc. Further, the data sources 111₁-111ₘ of the data elements may be various servers across a company network, may be located at servers on a public network, such as the internet, or a combination of a private and public networks. Furthermore, the slots of the individual descriptor can be employed to conduct a variety of different analyses. For example, one user may employ the descriptor to conduct an analysis of a stock price, while another user may utilize the descriptor to conduct an analysis on the overall value of a company issuing the stock. Here, a user can apply weights to the various data elements or slots to indicate a respective degree of importance of the data elements or slots in the particular analysis conducted. In each case, the weights, the validation tests applied and/or the validation functions used can be customized to the specific analysis conducted on the descriptor.

As another example, in the field of finance, the slots can be allocated to data elements providing material for analyses related to the issuance of mortgages. For example, one analysis can be directed to the determination of an interest rate for a customer, while another can be directed to determining a maximum mortgage amount. For example, such data elements can be directed to a funding cost incurred by a bank to raise funds to lend to a potential customer. Data elements can also include information indicating the risk of a loan default, information indicating an expected profit margin, and a potential customer's assets. Further, as described above with regard to the trading example, the data sources 111₁-111ₘ of the data elements may be located at various nodes across a private and/or a public network. Moreover, the weighting, the selection of validation tests applied and/or the selection of validation functions utilized can also be customized to the specific analysis conducted on the descriptor.

The present principles can be applied in virtually any field that employs composites of different types of information as a basis of opinions or decisions. As noted above, embodiments of the present principles provide substantial advantages, as they permit users to customize the validation of a data set in accordance with the specific analysis the user wishes to perform. In particular, the customization feature enable users to utilize incomplete records by confirming their sufficiency with respect to the specific analysis a user seeks to conduct.

Having described preferred embodiments of systems and methods for validation of ingested data (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer readable storage medium comprising a computer readable program code, wherein the computer readable program code when executed on a computer causes the computer to:
receive data elements for storage in slots of an individual descriptor;
select at least one validation test based on a weighting of the data elements that indicates a respective degree of importance of the data elements;
apply the selected at least one validation test to the data elements stored in the slots to generate respective validation results; and
generate a validation score indicating a sufficiency of the stored data elements based on the validation results.

2. The computer readable storage medium of claim 1, wherein the data elements provide material for analysis of a subject and wherein each weight of the data elements indicates a respective degree of importance of a corresponding data element in the analysis.

3. The computer readable storage medium of claim 2, wherein the validation score indicates a sufficiency of the stored data elements with respect to conducting the analysis of the subject.

4. The computer readable storage medium of claim 1, wherein causing the computer to generate comprises generating the validation score in accordance with a validation function applied to the validation results.

5. The computer readable storage medium of claim 4, further comprising:
causing the computer to select the validation function from a plurality of validation functions based on the weighting of the data elements.

6. The computer readable storage medium of claim 1, further comprising:
causing the computer to select the validation function in accordance with a user-specification of the validation function.

7. The computer readable storage medium of claim 1, wherein causing the computer to select comprises referencing pre-determined mappings between the slots of the individual descriptor and validation tests.

8. The computer readable storage medium of claim 1, wherein causing the computer to select the at least one validation test is dependent on the types of data for which the slots are dedicated.

9. A system for validating ingested data comprising:
a weighting module configured to assign weights to data elements to which storage slots of an individual descriptor are dedicated, wherein the weights indicate respective degrees of importance of the data elements;
a validation unit configured to apply at least one validation test to the data elements stored in the slots to generate respective validation results; and
a controller configured to receive the data elements, to store the data elements in storage slots of the individual descriptor in a storage medium and to generate a validation score indicating a sufficiency of the stored data elements based on the weights and on the validation results.

10. The system of claim 9, wherein the data elements provide material for analysis of a subject and wherein each weight of the data elements indicates a respective degree of importance of a corresponding data element in the analysis.

11. The system of claim 10, wherein the validation score indicates a sufficiency of the stored data elements with respect to conducting the analysis of the subject.

12. The system of claim 9, wherein the controller is further configured to apply a validation function to the validation results to generate the validation score.

13. The system of claim 12, wherein the controller is further configured to select the validation function from a plurality of validation functions based on the weights of the data elements.

14. The system of claim 12, wherein the controller is further configured to generate the validation function in accordance with a user-specification of the validation function.

15. The system of claim 9, wherein the validation unit is further configured to select the at least one validation test from a plurality of validation tests based on the weights of the data elements.

16. The system of claim 9, wherein the validation unit is further configured to select the at least one validation test based on the types of data for which the slots are dedicated.
